(19) United States
(12) Patent Application Publication
(10) Pub. No.: US 2011/0058053 A1
(43) Pub. Date: Mar. 10, 2011

(54) MOBILE TERMINAL WITH MULTIPLE CAMERAS AND METHOD FOR IMAGE PROCESSING USING THE SAME

(75) Inventor: Hyun Duk ROH, Seoul (KR)

(73) Assignee: PANTECH CO., LTD., Seoul (KR)

(21) Appl. No.: 12/875,963

(22) Filed: Sep. 3, 2010

(30) Foreign Application Priority Data
Sep. 8, 2009 (KR) 10-2009-0084571

(51) Int. Cl. H04N 5/225; G06K 9/36

(52) U.S. Cl. 348/218.1; 382/276; 348/222.1; 348/E05.024

(57) ABSTRACT

A mobile terminal includes: a first camera; a second camera; an image processor to process first image data generated by the first camera according to an interface format of a host processor; and a concurrent driver to process second image data generated by the second camera according to an output format of the image processor and to buffer the processed second image data to the host processor. A method for image processing of a mobile terminal includes, if both the first and second cameras operate in an ON state, the image processor processing the first image data of the first camera according to the interface format of the host processor, and the concurrent driver operating in an active mode to process the second image data of the second camera according to the output format of the image processor and buffering the arranged images to the host processor.

### CROSS-REFERENCE TO RELATED APPLICATION

This application claims priority from and the benefit of Korean Patent Application No. 10-2009-0084571, filed on Sep. 8, 2009, which is hereby incorporated by reference for all purposes as if fully set forth herein.

### BACKGROUND

1. Field

This disclosure relates to a mobile terminal, and more particularly, to a mobile terminal with multiple cameras and a method for image processing using the mobile terminal.

2. Discussion of the Background

As mobile terminals are widely used, various kinds of services using the mobile terminals, such as video calls, message reception/transmission, wireless Internet, or broadcasting in addition to voice call services have been introduced and commercialized. In relation to a camera function of a mobile terminal, the user may conveniently take a photograph using the camera mounted in the mobile terminal and easily transmit and receive photograph files or video files.

Recently, as video calls are commercially available, mobile terminals with a two cameras are provided. A configuration of such a mobile terminal is exemplified as follows. For example, the mobile terminal may be a two-camera device including a 1.12 mega pixel camera module and a 300 kilo pixel video graphics array (VGA)-grade low-definition charge coupled device (CCD) module. The mega-pixel camera module is mainly used for taking a photograph or a video, and the VGA-grade camera module is used for implementing a real-time video call.

However, the existing mobile terminal with two cameras includes only one interface to be commonly used, and generally has a structure in which two camera modules are selectively driven through a line bridge or a switch. In general, in order to process image data input from two cameras through a single image processor, a mobile terminal alternately drives the two cameras and receives the image data sequentially from the two cameras to perform post-processing.

During the operation of a main camera, the mobile terminal operates the main camera while allowing an auxiliary camera to be in a standby state and then processes image data of the main camera through the image processor. During the operation of the auxiliary camera, the mobile terminal operates the auxiliary camera while allowing the main camera to be in the standby state and then processes image data of the auxiliary camera through the image processor similar to the image processing of the image data of the main camera.

In this configuration, it is difficult to concurrently operate the main camera and the auxiliary camera. That is, due to a time delay required for camera initialization, image capture, data transmission, or the like, images that are generated concurrently cannot be received together, and image processing, such as real-time composition of images from two cameras, may not be performed.

Therefore, it may be difficult to concurrently receive image data from two cameras by concurrently driving the two camera modules or it may be difficult to concurrently process two pieces of image data received from the two camera modules.

### SUMMARY

Exemplary embodiments of the present invention provide a mobile terminal capable of concurrently driving two or more cameras mounted in the mobile terminal using a common interface, and a method for image processing using the mobile terminal.

Exemplary embodiments of the present invention provide a mobile terminal capable of processing, in real time, image data input from two or more cameras by concurrently driving the cameras and processing, such as composition or editing, to utilize the taken images in various ways, and a method for image processing using the mobile terminal.

Additional features of the invention will be set forth in the description which follows, and in part will be apparent from the description, or may be learned by practice of the invention.

An exemplary embodiment provides a mobile terminal including: a first camera to generate first image data; a second camera to generate second image data; an image processor to process the first image data; and a concurrent driver to process the second image data.

An exemplary embodiment provides a method for image processing of a mobile terminal including first and second cameras, the method including: operating the first camera to generate first image data; operating the second camera to generate second image data; processing the first image data through an image processor according to an interface format of a host processor and transmitting the processed first image data to the host processor; and processing the second image data through an image converter and buffering the processed second image data to the host processor.

An exemplary embodiment provides a method for image processing of a mobile terminal including first and second cameras, the method including: operating the first camera to generate first image data; operating the second camera in a standby state; transmitting the first image data to an image processor through a concurrent driver in a bypass mode; processing the first image data through the image processor according to an interface format of a host processor; and transmitting the processed first image data to the host processor.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram of a configuration of a mobile terminal according to an exemplary embodiment.

FIG. 2 is a diagram of an internal configuration of a concurrent driver illustrated in FIG. 1.

FIG. 3 illustrates an exemplary embodiment of an image converter illustrated in FIG. 2.

FIG. 4 illustrates an exemplary embodiment of a buffer illustrated in FIG. 2.

FIG. 5 illustrates an exemplary embodiment of the image converter illustrated in FIG. 2.

FIG. 6 illustrates an exemplary embodiment of the buffer illustrated in FIG. 2.

FIG. 7 is a flowchart of a method of image processing of a mobile terminal according to an exemplary embodiment.

FIG. 8 is a flowchart of a method of image processing of a mobile terminal according to an exemplary embodiment.

FIG. 9 is a flowchart of a method of image processing of a mobile terminal according to an exemplary embodiment.

### DETAILED DESCRIPTION OF THE ILLUSTRATED EMBODIMENTS

The invention is described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms a, an, etc. does not denote a limitation of quantity, but rather denotes the presence of at least one of the referenced item. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals denote like elements. The shape, size, and regions, and the like, of the drawing may be exaggerated for clarity.

Hereinafter, a mobile terminal according to exemplary embodiments will be described in detail with reference to the drawings.

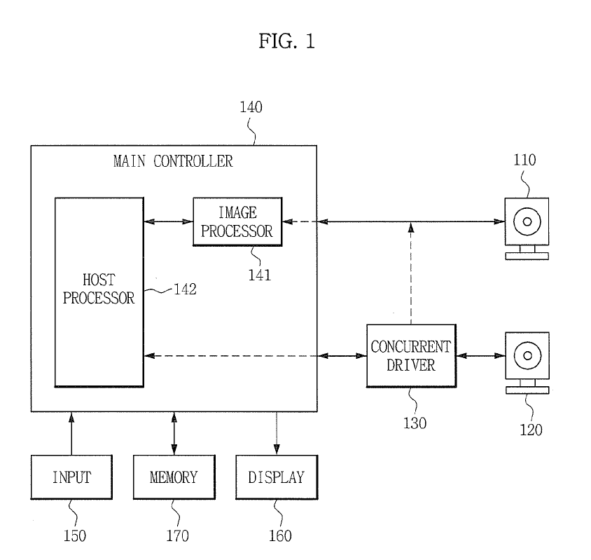

FIG. 1 is a diagram of a configuration of a mobile terminal according to an exemplary embodiment. Referring to FIG. 1, the mobile terminal includes a first camera 110, a second camera 120, a concurrent driver 130, a main controller 140, an input 150, a display 160, and a memory 170.

The first camera 110 and the second camera 120 each include a camera sensor to take a photograph of a subject, which may be a photographer (i.e., a user), or an object to be photographed, and to convert a taken optical signal into an electrical signal. The first camera 110 and the second camera 120 also each include a signal processor to convert an analog image signal taken by the camera sensor into digital image data. For example, the first camera 110 may be a high-definition main camera disposed on a rear surface of the mobile terminal, and the second camera 120 may be an auxiliary camera disposed on a front surface of the mobile terminal to be used for video calls or taking a photograph of a user.

The concurrent driver 130 converts the image data taken by the second camera 120 into an interface format of a host processor 142 to support concurrent driving of the first camera 110 and the second camera 120. That is, the concurrent driver 130 converts the image data obtained by the second camera 120 according to an output format of an image processor 141, which controls image processing to buffer the obtained image data to the host processor 142.

The main controller 140 is a part corresponding to a host chipset, which controls the overall operations of the mobile terminal and controls each component. The main controller 140 processes, such as composition/editing, the images and controls overall operations according to image processing or transferring. The main controller 140 may include the image processor 141 and the host processor 142.

The image processor 141 receives image data and performs image processing, such as auto white balance, auto exposure, color correction, and the like. The image processor 141 processes the image data taken by the first camera 110 into the interface format of the host processor 142 to transmit the processed data to the host processor 142. During video calls, the image processor 141 receives image data from the second camera 120 and processes the image data from the second camera 120 similarly to the image data of the first camera 110. An example of the image processor 141 may include a video front end (VFE) of camera firmware.

The host processor 142 receives the image data transmitted from the image processor 141 and/or from the concurrent driver 130 and stores the received image data in the memory 170. If there is a user request, the host processor 142 reads the image data stored in the memory 170 and processes, such as composition or editing, the image data and outputs the results according to the characteristics or size of the display 160.

The display 160 displays the images generated by the first camera 110 and/or the second camera 120 or the result of the processing (i.e., composition, editing, or the like) of two images on a screen according to the control of the host processor 142 to allow a user to visually check the image.

The input 150 may include keys for inputting numeral and text information and function keys for setting various functions. If the display 160 is implemented as a touch screen, the keys and function keys need not be included and numeral and text information may be input and the various functions may be set by touch inputs on the touch screen.

The memory 170 may be configured as a program memory, a data memory, and the like. The program memory stores programs for controlling general operations of the mobile terminal. The memory 170 may store programs for compositing or editing the images and videos taken by the first camera 110 and the second camera 120, and may store images used for composition and for editing.

The mobile terminal includes the host processor 142 with the single image processor 141. The host processor 142 concurrently drives the first camera 110 and the second camera 120 through the support of the concurrent driver 130, and receives the image data obtained by the first camera 110 and the second camera 120 to processes, such as composition and editing, the image data.

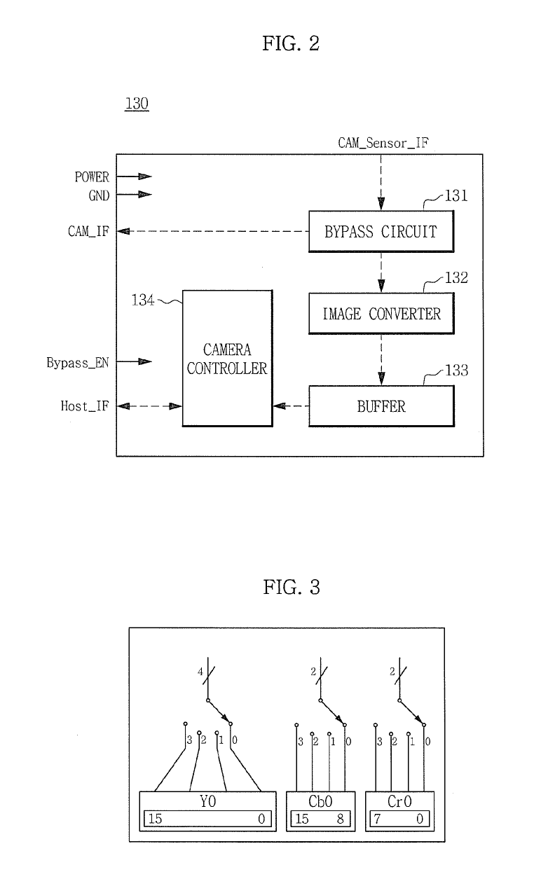

FIG. 2 is a diagram of an internal configuration of the concurrent driver 130 illustrated in FIG. 1. Referring to FIG. 2, the concurrent driver 130 includes a bypass circuit 131, an image converter 132, a buffer 133, and a camera controller 134.

The concurrent driver 130 may be operated in an active mode to perform a basic operation or in a bypass mode to perform video calls. According to the operation mode of the concurrent driver 130, a transmission route of the image taken by the second camera 120 is changed.

The concurrent driver 130 operates in the active mode if the first camera 110 and the second camera 120 are concurrently driven. In the active mode, the concurrent driver 130 inputs the image data output from the second camera 120 to the image converter 132. The image converter 132 stores the image data input from the second camera 120 in an order and in a form suitable for the structure of the buffer 133. If a suitable amount of data, as determined by the buffer 133, is stored, the buffer 133 informs the host processor 142 that data can be taken using a method such as interrupt. The host processor 142 may continuously take the data from the first camera 110 and the second camera 120 through a host interface, and may receive the image data from the first camera 110 and the second camera 120 through the host interface or control the concurrent driver 130.

The concurrent driver 130 operates in the bypass mode if the first camera 110 and the second camera 120 are not concurrently driven but only the second camera 120 is to be used. For example, if the user is to make a video call through the second camera 120 on the front surface of the mobile terminal, the concurrent driver 130 is set to the bypass mode. In the bypass mode, a data transmission route of the concurrent driver 130 is set to transmit to the image data from the second camera 120 to the image processor 141 at the front end of the host processor 142. If the image data is output from the second camera 120, the host processor 142 receives the image data of the second camera 120 through the image processor 141 to perform image processing similarly to the image processing of the first camera 110.

Operations of each component will be described in detail as follows.

The bypass circuit 131 opens the route of the image data output from the first camera 110 and the second camera 120 to the image processor 141 at the front end of the host processor 142 without processing. The bypass circuit 131 controls the transmission route of the image data taken by the second camera 120 according to the operation mode of the mobile terminal by switching between the image processor 141 positioned at the front end of the host processor 142 and the image converter 132 in the concurrent driver 130 through a switching terminal.

For example, in the bypass mode for video calls, the bypass circuit 131 is switched to transmit the image data taken by the second camera 120 to the host processor 142 via the image processor 141, i.e., the bypass circuit 131 switches the switching terminal to bypass the image converter 132. If the second camera 120 alone takes a photograph, or in the active mode in which the second camera 120 performs a shooting operation along with the first camera 110, the bypass circuit 131 switches the switching terminal to transmit the image data taken by the second camera 120 to the image converter 132.

The image converter 132 arranges the image data received from the second camera 120 according to the output format of the image processor 141 included in the main controller 140 thereby converting the format of the image data provided by the second camera 120 into the host interface format.

The buffer 133 sequentially stores the image data from the image converter 132, and if a predetermined degree of data is stored, the buffer 133 buffers the stored data to the host processor 142 under the control of the camera controller 134 in response to a request of the host processor 142.

The camera controller 134 communicates with the host processor 142 to generally control the operations of each component of the concurrent driver 130, and particularly, if a predetermined degree of image data is filled in the buffer 133, the camera controller 134 informs the host processor 142 that data is available. Thereafter, at the request of the host processor 142, the camera controller 134 buffers the image data from the second camera 120 to provide the image data to the host processor 142 in real time. Here, the host processor 142 may sequentially read the image data from the second camera 120, which is stored in a predetermined unit, by controlling the camera controller 134 and concurrently store a next unit of the corresponding data image in the buffer 133.

Concurrent driving of the first camera 110 and the second camera 120 is enabled by the concurrent driver 130. During the operation of the first camera 110, the mobile terminal post-processes image data input from the first camera 110 through the image processor 141 after operating the first camera 110 to transmit the image data to the host processor 142. If the first camera 110 alone performs a shooting operation, the concurrent driver 130 is in a high impedance state. Therefore, there is no need to turn on the second camera 120, for example, so as to be in the standby state, in order to operate the first camera 110.

If the second camera 120 alone performs a shooting operation (for example, during a video call), the concurrent driver 130 is set to the bypass mode. In the bypass mode, the first camera 110 waits in the standby state, and the host processor 142 switches the switching terminal of the bypass circuit 131 included in the concurrent driver 130 to transmit the image data from the second camera 120 to the image processor 141 and then operates the second camera 120. The image data of the second camera 120 is transmitted to the image processor 141 through the bypass circuit 131 of the concurrent driver 130, and the corresponding image data is processed similarly to the image data transmitted to the image processor 141 from the first camera 110.

If the first camera 110 and the second camera 120 are concurrently operated, the concurrent driver 130 is set to the active mode. The host processor 142 switches the switching terminal of the bypass circuit 131 toward the image converter 132 in the concurrent driver 130 and then operates the first camera 110 and the second camera 120. Images of the first camera 110 are transmitted to the host processor 142 through the image processor 141. Images of the second camera 120 are arranged according to the host interface format through the concurrent driver 130 and transmitted to the host processor 142 using a method such as an External Bus Interface II (EBI2).

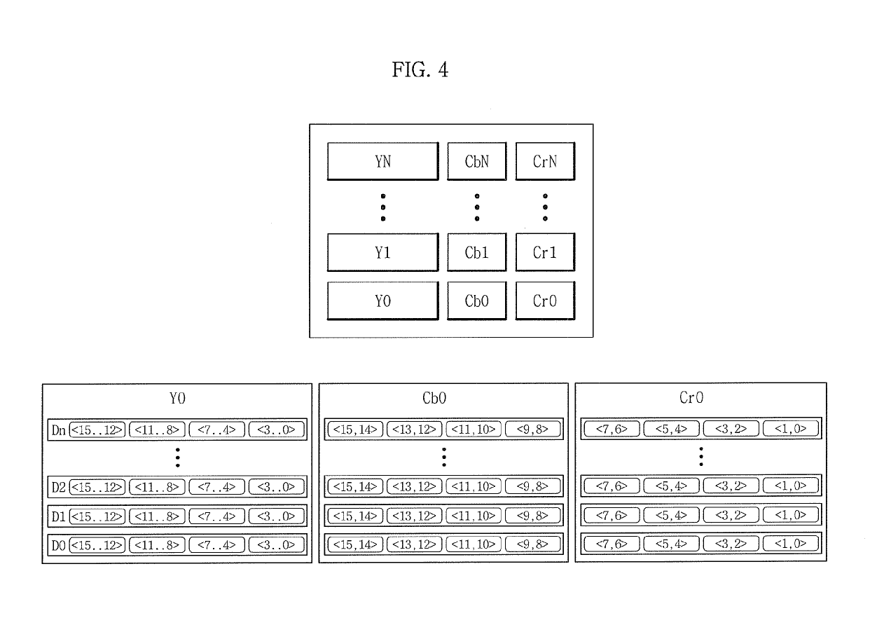

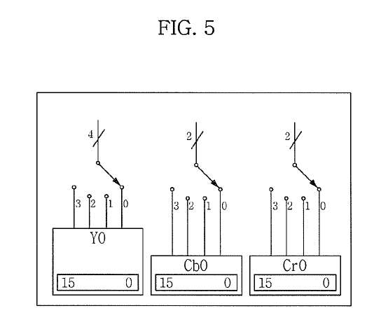

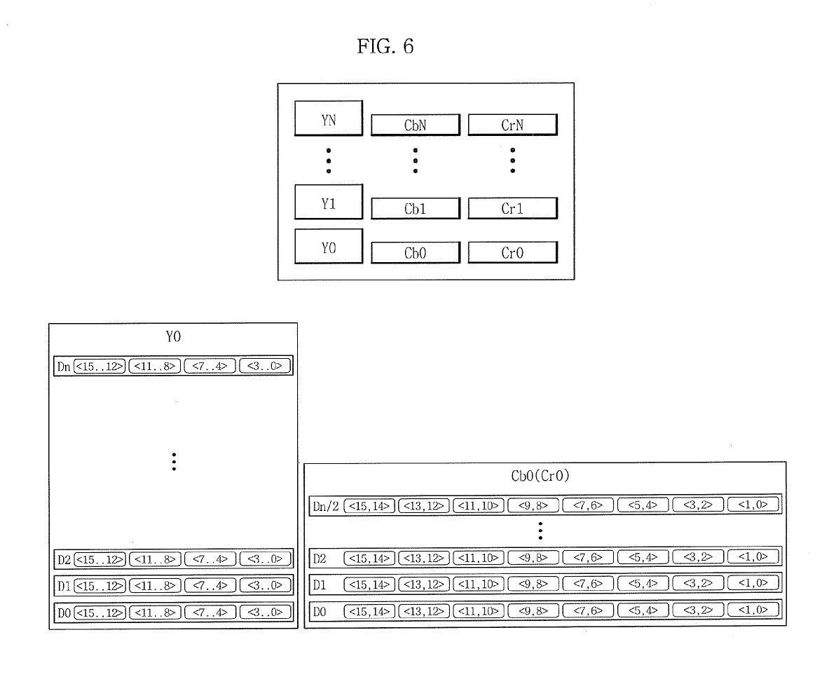

FIG. 3 illustrates an exemplary embodiment of the image converter 132 illustrated in FIG. 2, and FIG. 4 illustrates an exemplary embodiment of the buffer 133 illustrated in FIG. 2. In addition, FIG. 5 illustrates an exemplary embodiment of the image converter 132 illustrated in FIG. 2, and FIG. 6 illustrates an exemplary embodiment of the buffer 133 illustrated in FIG. 2.

For the concurrent driving of the first camera 110 and the second camera 120, the image converter 132 arranges image data output from the second camera 120 to convert the image data according to the host interface format. For example, the image converter 132 changes a YCbCr_{—}422 format of the image data output from the second camera 120 into a 16-bit host interface format through a switching structure as illustrated in FIG. 3 and stores the converted image data in the buffer 133. That is, so as to store the image data in the YCbCr_{—}422 format in the buffer 133, the corresponding image data is given a predetermined order and location to be converted according to the host interface format.

The buffer 133 buffers the corresponding image data to allow the host processor 142 to take the image data at an arbitrary time point. The buffer 133 may have a first in, first out (FIFO) structure to concurrently perform input and output. The size of the buffer 133 may be designed differently depending on a size difference between Y data and Cr and Cb data. In addition, the structure of the buffer 133 may be designed flexibly depending on the data format desired by the host processor 142. In order to prevent overflow or underflow or to respond to a situation that has occurred, the structure of the buffer 133 may be modified to a multiple structure buffer rather than a single structure buffer.

As described above, the structure of the buffer may be modified to various forms as well as the above-mentioned structure, and the host interface can also be modified to various forms, such as a serial peripheral interface (SPI), an universal serial bus (USB), an universal asynchronous receiver/transmitter (UART), and red-green-blue (RGB) connector from the 16-bit interface.

FIG. 3 and FIG. 4 respectively illustrate exemplary structures of the image converter 132 and the buffer 133 if the image data is stored in the form of Y0(dn<15 . . . 0> . . . d0<15 . . . 0>), Cb0(dn<15 . . . 8> . . . d0<15 . . . 8>), and Cr0(dn<7 . . . 0> . . . d0<7 . . . 0>).

FIG. 5 and FIG. 6 respectively illustrate exemplary structures of the image converter 132 and the buffer 133 if the image data is stored in the form of Y0(dn<15 . . . 0> . . . d0<15 . . . 0>), Cb0(dn/2<15 . . . 0> . . . d0<15 . . . 0>), and Cr0(dn/2<15 . . . 0> . . . d0<15 . . . 0>).

As described above, depending on the image processing method of the host processor 142, the buffer 133 may more smoothly supply image data. In addition, depending on the buffer structure, the image data output from the second camera 120 may be converted into YCbCr format determined according to a format acceptable to the host interface, for example, the form of Y0 . . . Yn, Cb0/Cr0 . . . Cbn/Crn, or the form of Y0 . . . Yn, Cb0 . . . Cbn/2, Cr0 . . . Crn/2. Otherwise, depending on the buffer structure, the image data output from the second camera 120 may be converted into YCrCb data format.

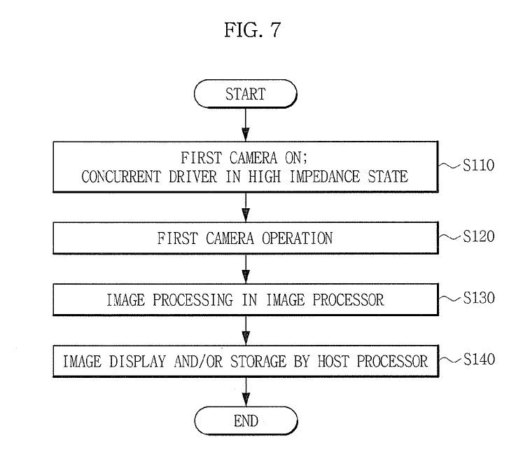

Hereinafter, a method of image processing of a mobile terminal according to exemplary embodiments will be described in detail with reference to FIGS. 7 to 9.

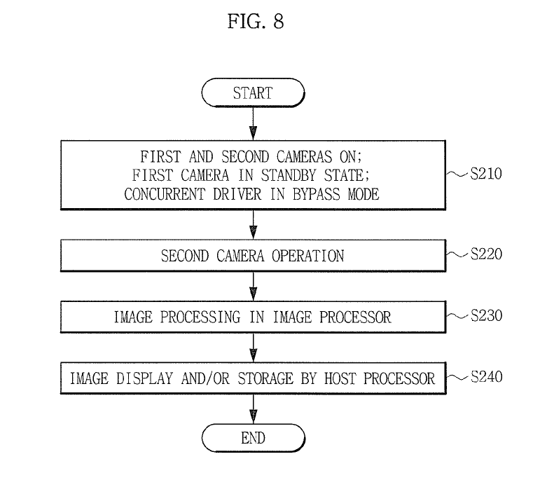

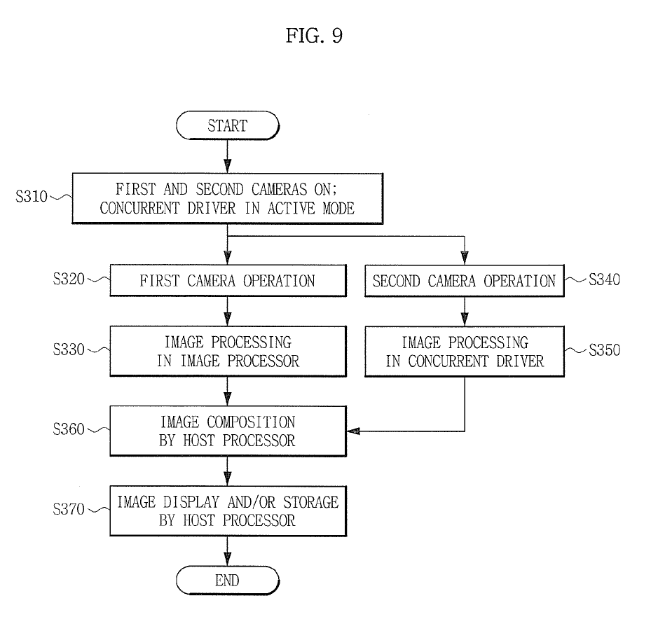

FIG. 7, FIG. 8, and FIG. 9 are flowcharts of methods of image processing of a mobile terminal according to exemplary embodiments. FIG. 7 illustrates a single shooting operation of the first camera 110. FIG. 8 illustrates a single shooting operation of the second camera 120 at a time of a video call. FIG. 9 illustrates a concurrent operation of the first camera 110 and the second camera 120.

Referring to FIG. 7, if the first camera 110 is turned on to be in an ON state and the second camera 120 maintains an OFF state, the concurrent driver 130 connected to the second camera 120 is in a high impedance state in operation S110. If the first camera 110 starts a shooting operation, image data is generated as the first camera 110 performs shooting and the generated image data is transmitted to the image processor 141 at the front end of the host processor 142 in operation S120. The image processor 141 processes the image data taken by the first camera 110 and transmits processed image data to the host processor 142 in operation S130, and the host processor 142 receives the image data processed through the image processor 141 to display the processed image data on the display 160 and/or to store the processed image data in the memory 170 in operation S140.

FIG. 8 illustrates a flowchart for operation of a mobile terminal during a video call in which the mobile terminal switches the transmission routes of the image data taken by the second camera 120 through the bypass circuit 131 of the concurrent driver 130 and transmits the image data taken by the second camera 120 to the image processor 141.

During the single shooting operation of the second camera 120 for a video call, the first camera 110 and the second camera 120 are both turned on to be in an ON state in operation S210. However, the first camera 110 waits in a standby state in operation S210. While the video call is performed, in order to receive the image data of the second camera 120 and display the image data of the second camera 120 on the screen of the display 160, the host processor 142 controls the camera controller 134 to set the concurrent driver 130 to the bypass mode.

Thereafter, the shooting operation of the second camera 120 is started in operation S220, and the image processor 141 processes the image data obtained by the second camera 120 similarly to the processing the image data of the first camera 110 in operation S230, i.e., the image data is processed in the image processor in operation S230. The image processor 141 transmits the processed image data to the host processor 142, and the host processor 142 displays and/or stores the image data transmitted in operation S240.

Referring to FIG. 9, both the first camera 110 and the second camera 120 are turned on to be in the ON state, and the concurrent driver 130 linked with the second camera 120 is set to the active mode in operation S310.

The first camera 110 generates first image data through the shooting operation and transmits the generated first image data to the image processor 141 of the host processor 142 to allow the image processor 141 to process the corresponding image data in operation S320. The image processor 141 processes the first image data generated by the first camera 110 according to the interface format of the host processor 142 and transmits the processed first image data from the first camera 110 to the host processor 142 in operation S330.

The second camera 120 operates in parallel with the first camera 110 operates to generate second image data through shooting in operation S340. The concurrent driver 130 converts the format of the second image data obtained by the second camera 120 into the host interface format through the image converter 132 and the buffer 133 in operation S350. That is, in order to support the concurrent driving of the first camera 110 and the second camera 120, the concurrent driver 130 buffers the second image data generated by the second camera 120 to the host processor 142 according to the output format of the image processor 141 through the internal image converter 132.

The image converter 132 arranges the second image data taken by the second camera 120 according to the output format of the image processor 141 and stores the arranged second image data in the buffer 133. If a predetermined amount of the second image data is stored in the buffer 133, the camera controller 134 informs the host processor 142 that such predetermined amount is stored, and the host processor 142 requests the buffer 133 for the at least a portion of the stored second image data and receives the second image data in operation S350.

In operation S360, the host processor 142 may receive images from the first camera 110 and the second camera 120 in real time and perform a simultaneous process, such as composition or editing, on the first image data obtained by the first camera 110 and the second image data obtained by the second camera 120. The image data processed by the host processor 142 is displayed by the display 160 and/or stored in the memory 170 in operation S370.

For example, the mobile terminal operates the first camera 110 and the second camera 120 in parallel with each other to simultaneously take multiple photographs in front of and/or at the back of the mobile terminal and thus acquires multiple types of images. Then, the photographer may compose the multiple images to check, through a single image, the appearance of the multiple images, and may send the image to others.

In addition, it is possible to process image data (e.g. image composition) taken by several cameras at the same time through the concurrent driving of the cameras. While the embodiment has been described above on the basis of the first camera 110 and the second camera 120, the number of the cameras that are concurrently driven is not limited to two, and the mobile terminal may concurrently drive two or more cameras to receive and process several images in real time. When the number of cameras is increased, each camera may communicate with the host processor 142 through respective concurrent drivers 130.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A mobile terminal, comprising:
a first camera to generate first image data;
a second camera to generate second image data;
an image processor to process the first image data; and
a concurrent driver to process the second image data.

2. The mobile terminal of claim 1, wherein the concurrent driver comprises:
an image converter to process the second image data received from the second camera according to an output format of the image processor; and
a buffer to store the second image data processed by the image converter and to buffer the stored image data to a host processor.

3. The mobile terminal of claim 2, wherein the concurrent driver further comprises a bypass circuit to control a transmission route of the second image data according to an operation mode by performing a switching operation between the image processor positioned at a front end of the host processor and the image converter of the concurrent driver.

4. The mobile terminal of claim 3, wherein the bypass circuit transmits the second image data to the image processor in a bypass mode, and transmits the second image data to the image converter in an active mode.

5. The mobile terminal of claim 1, wherein the concurrent driver is in a high impedance state during a single shooting operation of the first camera.

6. The mobile terminal of claim 1, wherein the first camera is in a standby state during a single shooting operation of the second camera.

7. The mobile terminal of claim 2, further comprising a host processor to receive the first image data from the image processor and the second image data from the image converter and to process the received first image data and the received second image data.

8. The mobile terminal of claim 3, wherein the current driver comprises:
a camera controller to control the bypass circuit, the image converter, and the buffer.

9. The mobile terminal of claim 8, wherein the camera controller transmits a signal to the host processor to indicate availability of the second image data in the buffer.

10. The mobile terminal of claim 9, wherein the camera controller buffers the second image data to provide the second image data to the host processor in response to a request from the host processor.

11. A method for image processing of a mobile terminal comprising a first camera and a second camera, the method comprising:
operating the first camera to generate first image data;
operating the second camera to generate second image data;
processing the first image data through an image processor according to an interface format of a host processor and transmitting the processed first image data to the host processor; and
processing the second image data through an image converter and buffering the processed second image data to the host processor.

12. The method of claim 11, wherein the processing of the second image data by the image converter is according to an output format of the image processor.

13. The method of claim 11, wherein the processing and buffering further comprises:
storing the processed second image data in a buffer; and
transmitting the stored second image data to the host processor.

14. The method of claim 11, further comprising: transmitting the second image data of the second camera to the host processor through the image processor.

15. The method of claim 11, further comprising: processing the first image data of the first camera and the second image data of the second camera through the host processor.

16. The method of claim 11, further comprising:
displaying a composition of the first image data and the second image data on a display.

17. A method for image processing of a mobile terminal comprising a first camera and a second camera, the method comprising:
operating the first camera to generate first image data;
operating the second camera in a standby state;
transmitting the first image data to an image processor through a concurrent driver in a bypass mode;
processing the first image data through the image processor according to an interface format of a host processor; and
transmitting the processed first image data to the host processor.

18. The method of claim 17, further comprising:
switching the second camera from the standby state to an operating state to generate second image data;
switching the concurrent driver to an active mode;
transmitting the first image data to an image converter of the concurrent driver;
processing the first image data through an image converter and buffering the processed first image data to the host processor.

19. The method of claim 18, further comprising:
transmitting the second image data to the image processor;
processing the second image data through the image processor according to the interface format of the host processor; and
transmitting the processed second image data to the host processor.

20. The method of claim 17, further comprising:
switching the concurrent driver to a high impedance state;
operating the second camera to generate second image data;
transmitting the second image data to the image processor;
processing the second image data through the image processor according to the interface format of the host processor; and
transmitting the processed second image data to the host processor.
